(19) United States
(12) Patent Application Publication
(10) Pub. No.: US 2009/0228172 A1
(43) Pub. Date: Sep. 10, 2009

(54) VEHICLE-TO-VEHICLE POSITION AWARENESS SYSTEM AND RELATED OPERATING METHOD

(75) Inventors: CRAIG R. MARKYVECH, ROMULUS, MI (US); ANTHONY G. LOBAZA, BLOOMFIELD HILLS, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/042,490

(22) Filed: Mar. 5, 2008

(51) Int. Cl. G08G 1/16; G01C 21/00; G01S 5/00

(52) U.S. Cl. 701/36; 701/300; 342/454; 701/207; 701/213

(57) ABSTRACT

A vehicle-to-vehicle position awareness system that utilizes wireless communication techniques is provided. An embodiment of the system includes a detection and ranging system located on a host vehicle, where the detection and ranging system is configured to sense a neighboring vehicle proximate to the host vehicle. In response to the detection of the neighboring vehicle, the detection and ranging system generates neighboring vehicle data that indicates a position of the neighboring vehicle relative to the host vehicle. The position awareness system also includes a traffic modeler that is configured to process the neighboring vehicle data and, in response thereto, generate a virtual traffic model for the host vehicle. The position awareness system also employs a wireless transmitter that wirelessly transmits host vehicle model data that conveys the virtual traffic model. Compatible vehicles in the vicinity of the host vehicle can receive and process the host vehicle model data to generate their own virtual traffic models.

### TECHNICAL FIELD

The present invention generally relates to vehicle communication systems, and more particularly relates to an onboard system for obtaining positional awareness of vehicles near the host vehicle.

### BACKGROUND OF THE INVENTION

It is now commonplace for vehicles to include onboard electronic control, communication, and safety systems. For example, many vehicles now include navigation systems that utilize wireless global positioning system (GPS) technology to pinpoint the real-time location of the host vehicle. As another example, some vehicles now include adaptive cruise control systems that employ wireless sensing techniques to detect the distance between the host vehicle and the vehicle (if any) in front of the host vehicle. An adaptive cruise control system uses the detected distance to influence the operation of the cruise control feature of the host vehicle, e.g., to modulate the speed and/or braking of the host vehicle.

In addition to adaptive cruise control systems, some automobile manufacturers are developing onboard safety systems that are intended to reduce the occurrence and severity of accidents or collisions. For example, wireless sensors and rearview video cameras are commonly utilized to assist drivers when operating their vehicles in reverse. In addition, automated collision avoidance systems are intended to provide the host vehicle with information related to the location of other vehicles within close proximity of the host vehicle, where such information is to be used to avoid accidents or reduce damage to the vehicle in the event of an unavoidable accident.

### SUMMARY OF THE INVENTION

An embodiment of a vehicle-to-vehicle position awareness system is described herein. The system includes a detection and ranging system located on a host vehicle, a traffic modeler coupled to the detection and ranging system, and a wireless transmitter coupled to the traffic modeler. The detection and ranging system is configured to sense a neighboring vehicle proximate to the host vehicle, and, in response thereto, generate neighboring vehicle data that indicates a position of the neighboring vehicle relative to the host vehicle. The traffic modeler is configured to process the neighboring vehicle data and, in response thereto, generate a virtual traffic model for the host vehicle. The wireless transmitter is configured to wirelessly transmit host vehicle model data that conveys the virtual traffic model.

Another embodiment of a vehicle-to-vehicle position awareness system is also provided. This system includes a wireless receiver located on a host vehicle, a traffic modeler coupled to the wireless receiver, and a traffic awareness system coupled to the traffic modeler. The wireless receiver is configured to wirelessly receive neighboring vehicle model data from a neighboring vehicle, the neighboring vehicle model data conveying a first virtual traffic model for the neighboring vehicle. The traffic modeler is configured to process the first virtual traffic model and, in response thereto, generate a second virtual traffic model for the host vehicle. In addition, the traffic awareness system is configured to predict impending traffic conditions proximate the host vehicle, based upon the second virtual traffic model.

An embodiment of a vehicle-to-vehicle position awareness method is also provided. The method involves: wirelessly sensing, from a host vehicle, a neighboring vehicle that is proximate to the host vehicle; generating neighboring vehicle data that indicates a position of the neighboring vehicle relative to the host vehicle; generating a virtual traffic model for the host vehicle, using the neighboring vehicle data; and wirelessly broadcasting host vehicle model data that conveys the virtual traffic model.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWINGS

The present invention will hereinafter be described in conjunction with the following drawing figures, wherein like numerals denote like elements, and

FIG. 1 is a schematic representation of an exemplary operating environment for an embodiment of a vehicle-to-vehicle position awareness system;

FIG. 2 is a top view of a host vehicle, showing an exemplary sensor detection zone;

FIG. 3 is a schematic representation of onboard elements of an embodiment of a vehicle-to-vehicle position awareness system; and

FIG. 4 is a flow chart that illustrates an embodiment of a vehicle-to-vehicle position awareness process.

### DESCRIPTION OF AN EXEMPLARY EMBODIMENT

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 3 depicts one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard,” and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

For the sake of brevity, conventional techniques related to wireless data transmission, radar and other detection systems, GPS systems, vector analysis, traffic modeling, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

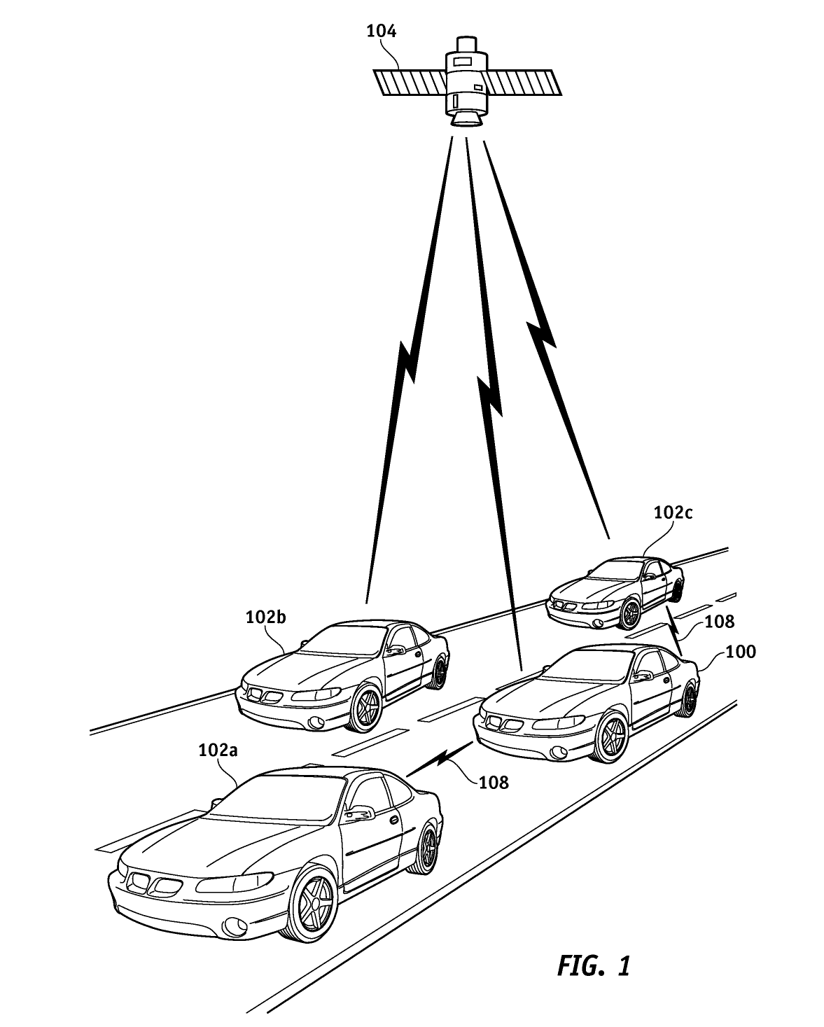

FIG. 1 is a schematic representation of an exemplary operating environment for an embodiment of a vehicle-to-vehicle position awareness system that is configured as described herein. For simplicity and convenience, the system will be described here with reference to a host vehicle 100 and a plurality of neighboring vehicles 102 that are proximate to host vehicle 100. In this regard, host vehicle 100 includes an onboard vehicle-to-vehicle position awareness system, and neighboring vehicles 102 may, but need not, have compatible position awareness systems. The onboard position awareness system of host vehicle 100 is suitably configured to generate a virtual traffic model for host vehicle 100, which may serve as an input to another onboard system or component, such as a traffic awareness system, a collision avoidance system, a telematics system, a navigation system, or the like. Notably, host vehicle 100 can transmit its virtual traffic model to one or more neighboring vehicles 102, thus enabling each of those neighboring vehicles 102 to create a more robust and accurate virtual traffic model for itself. Likewise, host vehicle 100 may be configured to receive one or more of the virtual traffic models generated by neighboring vehicles 102 for purposes of generating and updating its own virtual traffic model.

As used herein, a “virtual traffic model” is a simulated model of the environment surrounding the vehicle associated with that particular virtual traffic model. A virtual traffic model can be a computer-generated virtual reality model that includes vector calculations for each vehicle of interest within the area of interest, where a vector for a vehicle defines the current heading, position or location, speed, and acceleration/deceleration of the vehicle. A virtual traffic model may also include projected, predicted, or extrapolated characteristics for the vehicle that enable the vehicle-to-vehicle position awareness system to predict or anticipate the heading, position, speed, and possibly other parameters of the vehicle at some time in the future. In certain embodiments, a virtual traffic model includes information about the host vehicle itself, and information about neighboring vehicles within close proximity of the host vehicle. Moreover, a virtual traffic model may include information about the environment in which the host vehicle is located, including, without limitation, data related to: the surrounding landscape or hardscape; the road, freeway, or highway upon which the host vehicle is traveling (e.g., navigation or mapping data); lane information; speed limits for the road, freeway, or highway upon which the host vehicle is traveling; and other objects in the zone of interest, such as trees, buildings, signs, light posts, etc.

As described in more detail below, an embodiment of host vehicle 100 generates its virtual traffic model using: (1) position data obtained or derived from a positioning system; (2) neighboring vehicle data that indicates the positions of neighboring vehicles 102; and (3) virtual traffic models received from neighboring vehicles 102. The embodiment depicted in FIG. 1 cooperates with global positioning system (GPS) satellites 104 in a conventional manner to obtain GPS data for host vehicle 100. Notably, the position awareness system can still function even though one or more neighboring vehicles 102 are not GPS-capable. For example, neighboring vehicle 102a in FIG. 1 does not receive GPS signals from GPS satellites 104 and, therefore, does not obtain GPS data for itself.

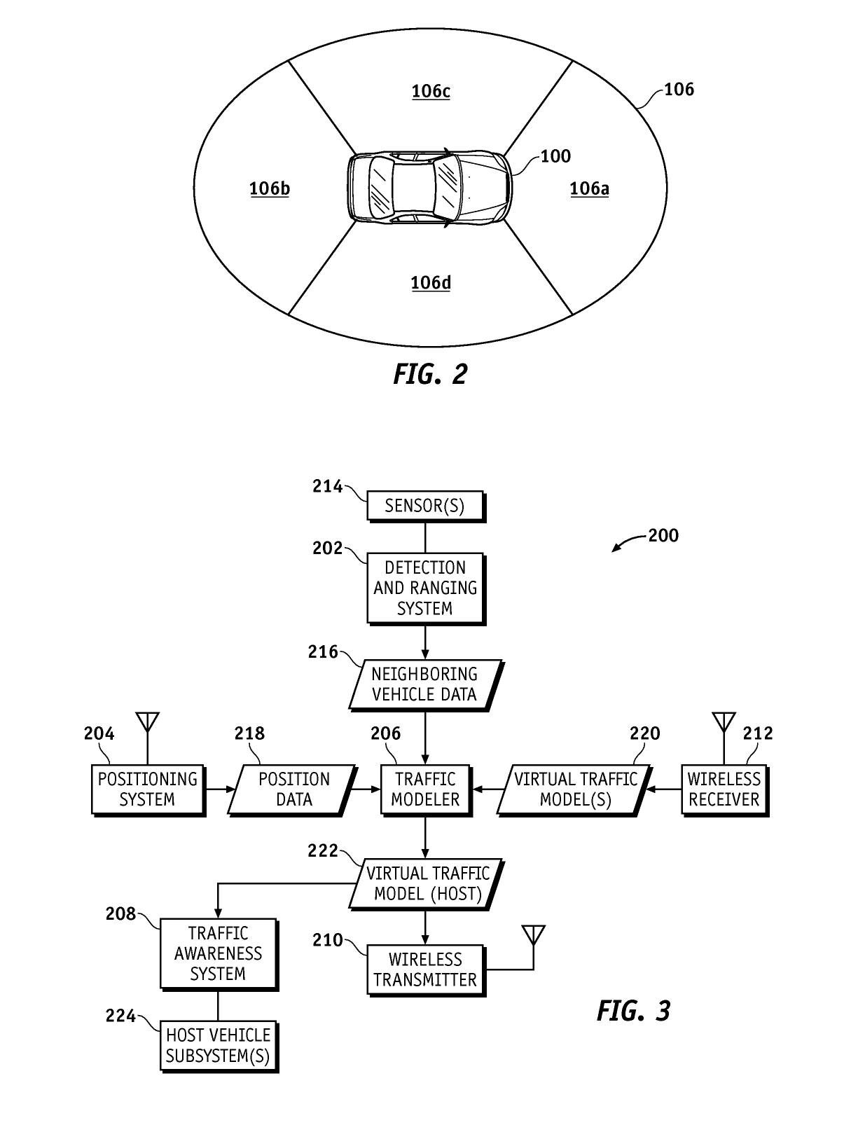

Host vehicle 100 may obtain neighboring vehicle data using a suitably configured onboard detection and ranging system. In certain embodiments, the onboard detection and ranging system includes or is implemented as a radar system. Preferably, the detection and ranging system uses a plurality of sensors positioned around host vehicle 100 in strategic locations that enable the detection and ranging system to sense/detect neighboring vehicles 102 within a detection zone surrounding host vehicle 100. In this regard, FIG. 2 is a top view of host vehicle 100, showing an exemplary sensor detection zone 106 for host vehicle 100. For illustrative purposes, detection zone 106 is divided into four subzones corresponding to a fore sensor zone 106a, an aft sensor zone 106b, a driver side sensor zone 106c, and a passenger side sensor zone 106d. This arrangement corresponds to an embodiment having four sensors for the detection and ranging system, although an embodiment of host vehicle 100 may include more or less than four sensors. It should be appreciated that in operation each of these sensor zones will correspond to a three-dimensional space that need not be shaped or sized as depicted in FIG. 2, and these sensor zones will likely overlap with one another. Moreover, the specific size, shape, and range of each sensor zone (which may be adjustable in the field) can be chosen to suit the needs of the particular deployment and to ensure that host vehicle 100 will be able to detect all neighboring vehicles of interest.

As mentioned previously, host vehicle 100 is configured to broadcast its virtual traffic model for reception by compatible neighboring vehicles 102 located within the transmit range of host vehicle 100. FIG. 1 depicts this broadcast transmission via wireless links 108. FIG. 1 depicts a scenario where neighboring vehicles 102a and 102c receive the virtual traffic model broadcast by host vehicle 100, and where neighboring vehicle 102b does not receive the virtual traffic model from host vehicle 100 (due to incompatibility, a poor communication link, a transmission error, or the like). In practice, host vehicle 100 may employ a relatively short range wireless data communication scheme for exchanging virtual traffic models with neighboring vehicles 102. A short range wireless protocol, such as one compatible with IEEE Specification 802.11 (any variant) may be desirable to ensure that host vehicle 100 receives information from surrounding vehicles that might actually affect the traffic pattern near host vehicle 100, while at the same time limiting the amount of irrelevant information (from distant vehicles) received by host vehicle 100. For example, it may be desirable to employ a wireless data communication scheme having a range of about 1000 yards or less for purposes of the vehicle-to-vehicle communication described herein.

FIG. 3 is a schematic representation of onboard elements of an embodiment of a vehicle-to-vehicle position awareness system 200, which may be located on a host vehicle, such as host vehicle 100 in FIG. 1. The various illustrative blocks, modules, processing logic, and components described in connection with the embodiments disclosed herein may be implemented or performed with one or more of: a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration. As one practical embodiment, the host vehicle may include suitably configured electronic control modules (ECMs) that incorporate the functionality of position awareness system 200.

Position awareness system 200 generally includes, without limitation: a detection and ranging system 202; a positioning system 204; a traffic modeler 206; a traffic awareness system 208; a wireless transmitter 210; and a wireless receiver 212. These and other elements of position awareness system 200 are coupled together in an appropriate manner to accommodate the communication of data, control commands, and signals as needed to support the operation of position awareness system 200. The elements depicted in FIG. 3 are all onboard elements in that they are all located on, carried by, or integrated into the host vehicle. Each of these elements is described in more detail below.

Detection and ranging system 202 is suitably configured to sense neighboring vehicles that are proximate to the host vehicle. As mentioned above with reference to FIG. 2, detection and ranging system 202 may include or cooperate with one or more sensors 214 that are strategically positioned on the host vehicle to provide a desired detection zone surrounding the host vehicle. Detection and ranging system 202 and sensors 214 may utilize one or more sensing or detection technologies such as, without limitation: radar; infrared; acoustic; video imaging; or the like. Detection and ranging system 202 responds to the detection or sensing of a neighboring vehicle by generating neighboring vehicle data 216 that indicates, conveys, or otherwise characterizes a position of that neighboring vehicle relative to the host vehicle. This neighboring vehicle data 216 may include or convey, without limitation: the current distance between the host vehicle and the neighboring vehicle; position data (e.g., GPS coordinates) of the neighboring vehicle; position coordinates of the neighboring vehicle relative to the neighboring vehicle; the vector associated with the neighboring vehicle; or the like. For example, the host vehicle preferably sends at least the current position data and vector data for the neighboring vehicle. In certain embodiments, detection and ranging system 202 can detect the presence of any number of neighboring vehicles within the detection zone of the host vehicle. As shown in FIG. 3, the neighboring vehicle data 216 serves as an input to traffic modeler 206.

Positioning system 204 is suitably configured to determine position data 218 for the host vehicle, where position data 218 includes, conveys, or represents data that indicates a current location of the host vehicle relative to a location domain utilized by position awareness system 200. For example, position data 218 may convey information related to the latitude, longitude, altitude (relative to a reference, such as sea level), heading, pitch, and/or yaw of the host vehicle. In practice, position data 218 or any portion thereof may be GPS-derived and/or derived from other information such as onboard systems. Notably, position data 218 obtained at two or more points in time may be used to derive vectors for the respective vehicle. As shown in FIG. 3, position data 218 serves as another input to traffic modeler 206. In certain embodiments, positioning system 204 includes an onboard GPS system that receives GPS data from GPS satellites, and processes the GPS data to obtain GPS coordinates for the host vehicle. GPS systems are well known and commonplace and, therefore, the operation of GPS systems will not be described in detail here.

Wireless receiver 212 wirelessly receives neighboring vehicle model data from one or more neighboring vehicles located near the host vehicle. In certain embodiments, wireless receiver 212 may also be configured to receive position data (e.g., GPS coordinates) from neighboring vehicles, where the received position data is generated by positioning systems onboard the neighboring vehicles. Wireless receiver 212 may be deployed such that it also supports other wireless data communication features of the host vehicle. As mentioned above, wireless receiver 212 may be a relatively short range receiver that is configured for compatibility with an appropriate short range wireless data communication scheme, such as IEEE Specification 802.11 (Wi-Fi), the BLUETOOTH® short range wireless communication protocol, 802.11p (also known as Dedicated Short Range Communication or DSRC), or the like. Accordingly, the neighboring vehicle model data may be formatted, arranged, and/or packaged as needed for transmission in a manner that is compatible with the particular wireless data communication technique and protocol. The neighboring vehicle model data includes, conveys, or represents one or more virtual traffic models 220 generated by the respective neighboring vehicles. In turn, the virtual traffic models 220 serve as additional inputs to traffic modeler 206.

A wireless communication link between wireless receiver 212 and a neighboring vehicle may also accommodate the forwarding of data by the neighboring vehicle. In other words, the neighboring vehicle may effectively function as a repeater that receives a virtual traffic model (and/or other data) from a third vehicle and then forwards that virtual traffic model (without modifying it) to the host vehicle. This allows position awareness system 200 to process information related to vehicles that might be more than one vehicle removed from itself. In this regard, position awareness system 200 may include processing intelligence that enables it to determine whether or not to process data received from distant vehicles. For example, data generated by a vehicle that is far removed may be irrelevant to the host vehicle, and the host vehicle may decide to disregard such data.

For this particular embodiment, traffic modeler 206 processes neighboring vehicle data 216, position data 218, virtual traffic models 220 for the neighboring vehicle, and other information (if needed) and, in response to that input data, generates (or updates) the virtual traffic model 222 for the host vehicle. As described above, virtual traffic model 222 may be a virtual reality representation of the current traffic conditions near the host vehicle. Virtual traffic model 222 may include vehicle vector information for the host vehicle and vehicle vector information for any neighboring vehicle of interest. This vector information enables vehicle awareness system 200 to predict traffic conditions in the immediate future, based on the current state of the host and neighboring vehicles. In practice, vehicle vector information may include information related to the speed, heading, acceleration/deceleration, and absolute position of the respective vehicle.

Traffic modeler 206 can be suitably configured to perform vector analysis, virtual reality modeling, minimum/maximum acceleration computation, minimum/maximum heading change computation, and other techniques to generate virtual traffic model 222. Traffic modeler 206 may also be configured to derive or calculate position data (e.g., GPS coordinates) of a neighboring vehicle based upon the position data 218 of the host vehicle and the neighboring vehicle data 216. This feature is particularly desirable because it enables position awareness system 200 to obtain position data of neighboring vehicles that are not fully compatible with the host vehicle. In other words, position awareness system 200 need not rely on vehicle-to-vehicle communication between the host vehicle and the neighboring vehicle to obtain position data for the neighboring vehicle.

As described above, wireless receiver 212 receives neighboring vehicle model data, and traffic modeler 206 uses the virtual traffic models conveyed in the neighboring vehicle model data to generate a more robust and accurate virtual traffic model 222 for the host vehicle. Similarly, wireless transmitter 210 is suitably configured to wirelessly transmit host vehicle model data that conveys the virtual traffic model 222 for the host vehicle. For this embodiment, wireless transmitter 210 transmits the host vehicle model data in a broadcast manner (rather than a point-to-point manner) such that all neighboring vehicles within the transmit range of wireless transmitter 210 can potentially receive virtual traffic model 222 for use in generating/updating their own virtual traffic models.

Wireless transmitter 210 may be deployed such that it also supports other wireless data communication features of the host vehicle. In practice, wireless transmitter 210 may be a relatively short range transmitter that is configured for compatibility with an appropriate short range wireless data communication scheme, such as IEEE Specification 802.11 (Wi-Fi), the BLUETOOTH® short range wireless communication protocol, or the like. Accordingly, the host vehicle model data may be formatted, arranged, and/or packaged as needed for transmission in a manner that is compatible with the particular wireless data communication technique and protocol.

The virtual traffic model 222 for the host vehicle may also serve as an input to traffic awareness system 208. Traffic awareness system 208 is suitably configured to predict, estimate, project, or extrapolate impending traffic conditions proximate the host vehicle, where the operation of traffic awareness system 208 is based upon and influenced by virtual traffic model 222. In certain embodiments, traffic awareness system 208 and/or traffic modeler 206 can be configured such that the vector analysis and virtual traffic modeling algorithms consider practical operating and environmental characteristics and conditions. For example, position awareness system 200 can be suitably configured to contemplate practical vehicle performance characteristics such as tire traction, braking distances for different speeds, maximum acceleration/deceleration, turning radius, and the like. In addition, position awareness system 200 can be suitably configured to determine and consider the location (relative to a reference such as sea level) of the host and neighboring vehicles. This will allow position awareness system 200 to accurately model the presence of bridges, tunnels, overpasses, underpasses, and the like.

In certain embodiments, traffic awareness system 208 is coupled to one or more host vehicle subsystems 224, and traffic awareness system 208 can automatically control the operation of host vehicle subsystems 224 in a manner that is dependent upon the predicted impending traffic conditions. For example, traffic awareness system 208 may include, cooperate with, or be realized as a collision avoidance system for the host vehicle. In operation, the collision avoidance system can analyze or process virtual traffic model 222 to determine the likelihood of an accident or collision in the immediate or near future. If that is indeed the case, then host vehicle subsystems 224 can be controlled or adjusted in an attempt to avoid or prevent the collision and/or to reduce any damage that might occur to the host vehicle. In this regard, traffic awareness system 208 may be configured to control the operation of onboard systems such as, without limitation: the braking system; the throttle system; the steering system; the fuel system; the electrical system; the traction control system; the telematics system; the airbag deployment system; and/or the driver interface system (warning indicators, alert notifications, display lights, etc.).

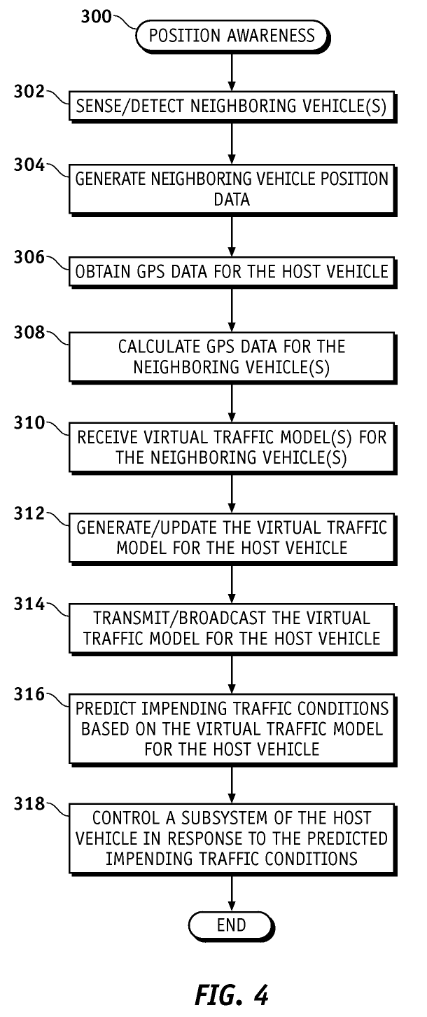

FIG. 4 is a flow chart that illustrates an embodiment of a vehicle-to-vehicle position awareness process 300. The various tasks performed in connection with process 300 may be performed by software, hardware, firmware, or any combination thereof. For illustrative purposes, the following description of process 300 may refer to elements mentioned above in connection with FIGS. 1-3. In practice, portions of process 300 may be performed by different elements of the described system, e.g., the detection and ranging system, the traffic modeler, or the traffic awareness system. It should be appreciated that process 300 may include any number of additional or alternative tasks, the tasks shown in FIG. 4 need not be performed in the illustrated order, and process 300 may be incorporated into a more comprehensive procedure or process having additional functionality not described in detail herein.

This embodiment of position awareness process 300 wirelessly senses one or more neighboring vehicles that are proximate to the host vehicle (task 302). For simplicity, process 300 will be described with reference to the processing of only one neighboring vehicle. It should be appreciated that process 300 is actually capable of concurrently processing data for any number of neighboring vehicles.

In response to task 302, process 300 generates neighboring vehicle position data that indicates a position of the neighboring vehicle relative to the host vehicle (task 304). In addition, process 300 may obtain position data—GPS data in this example—for the host vehicle (task 306), and calculate position data—GPS data in this example—for the neighboring vehicle (task 308). During task 308, process 300 calculates the position data for the neighboring vehicle from the position data for the host vehicle and from the neighboring vehicle position data. Alternatively, process 300 may obtain the position data for the neighboring vehicle directly from the neighboring vehicle itself (rather than deriving it in the manner described above).

Process 300 may also wirelessly receive neighboring vehicle model data from the neighboring vehicle, where the received data conveys the virtual traffic model for the neighboring vehicle (task 310). Thereafter, process 300 can generate or update the virtual traffic model for the host vehicle (task 312). For this embodiment, task 312 uses the neighboring vehicle position data, the GPS data, and the virtual traffic model of the neighboring vehicle to generate the virtual traffic model for the host vehicle.

The most current version of the virtual traffic model for the host vehicle can then be wirelessly broadcast by the host vehicle (task 314). As mentioned above, the host vehicle may transmit host vehicle model data that conveys the virtual traffic model in an appropriate format. This broadcast allows other vehicles, including the neighboring vehicle, to leverage the virtual traffic model generated by the host vehicle.

The virtual traffic model of the host vehicle can also be used to predict impending traffic conditions proximate to the host vehicle (task 316). Moreover, process 300 can automatically control one or more subsystems of the host vehicle in response to the predicted impending traffic conditions. For example, if process 300 predicts no potential collisions or unsafe conditions, then task 318 may cause the subsystems to function in a normal manner. On the other hand, if process 300 predicts a potential accident, then task 318 may take control of a subsystem such as the braking system, the traction control system, or the steering system as needed. In this manner, the actual operation performed during task 318 is dependent upon the predicted impending traffic conditions.

The detection of neighboring vehicles, the updating of the virtual traffic model for the host vehicle, the wireless communication of incoming and outgoing virtual traffic models, the calculation of GPS coordinates, and other processing and data communication tasks described herein are performed in a rapid and periodic manner. Indeed, an iteration of process 300 may be completed in several milliseconds, resulting in nearly real-time updating and processing of traffic conditions. Such rapid processing and response times are desirable to support a practical deployment that must contemplate vehicles traveling at highway speeds.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A vehicle-to-vehicle position awareness system comprising:
a detection and ranging system located on a host vehicle, the detection and ranging system being configured to sense a neighboring vehicle proximate to the host vehicle, and, in response thereto, generate neighboring vehicle data that indicates a position of the neighboring vehicle relative to the host vehicle;
a traffic modeler coupled to the detection and ranging system, the traffic modeler being configured to process the neighboring vehicle data and, in response thereto, generate a virtual traffic model for the host vehicle; and
a wireless transmitter coupled to the traffic modeler, the wireless transmitter being configured to wirelessly transmit host vehicle model data that conveys the virtual traffic model.

2. The system of claim 1, wherein the detection and ranging system comprises a radar system.

3. The system of claim 1, wherein the detection and ranging system comprises a plurality of sensors positioned around the host vehicle and configured to sense neighboring vehicles within a detection zone surrounding the host vehicle.

4. The system of claim 1, further comprising a positioning system located on the host vehicle, the positioning system being configured to determine position data for the host vehicle, wherein:
the traffic modeler is coupled to the positioning system; and
the traffic modeler is configured to process the neighboring vehicle data and the position data to generate the virtual traffic model for the host vehicle.

5. The system of claim 4, wherein the positioning system comprises a global positioning system.

6. The system of claim 1, wherein the virtual traffic model includes first vehicle vector information for the host vehicle and second vehicle vector information for the neighboring vehicle.

7. The system of claim 6, wherein:
the first vehicle vector information comprises information related to the absolute position, speed, heading, and acceleration/deceleration of the host vehicle; and
the second vehicle vector information comprises information related to the absolute position, speed, heading, and acceleration/deceleration of the neighboring vehicle.

8. The system of claim 1, wherein the wireless transmitter comprises a short range transmitter configured to broadcast the host vehicle model data to other vehicles, including the neighboring vehicle.

9. A vehicle-to-vehicle position awareness system comprising:
a wireless receiver located on a host vehicle, the wireless receiver being configured to wirelessly receive neighboring vehicle model data from a neighboring vehicle, the neighboring vehicle model data conveying a first virtual traffic model for the neighboring vehicle;
a traffic modeler coupled to the wireless receiver, the traffic modeler being configured to process the first virtual traffic model and, in response thereto, generate a second virtual traffic model for the host vehicle; and
a traffic awareness system coupled to the traffic modeler, the traffic awareness system being configured to predict impending traffic conditions proximate the host vehicle, based upon the second virtual traffic model.

10. The system of claim 9, wherein the traffic awareness system comprises a collision avoidance system.

11. The system of claim 9, further comprising a detection and ranging system located on the host vehicle, the detection and ranging system being configured to sense a second neighboring vehicle proximate to the host vehicle, and, in response thereto, generate second neighboring vehicle data that indicates a position of the second neighboring vehicle relative to the host vehicle.

12. The system of claim 11, wherein:
the traffic modeler is coupled to the detection and ranging system; and
the traffic modeler is configured to generate the second virtual traffic model in response to both the second neighboring vehicle data and the first virtual traffic model.

13. The system of claim 9, further comprising a wireless transmitter coupled to the traffic modeler, the wireless transmitter being configured to wirelessly transmit host vehicle model data that conveys the second virtual traffic model.

14. The system of claim 9, further comprising a positioning system located on the host vehicle, the positioning system being configured to determine position data for the host vehicle, wherein:
the traffic modeler is coupled to the positioning system; and
the traffic modeler is configured to process the neighboring vehicle model data and the position data to generate the second virtual traffic model for the host vehicle.

15. A vehicle-to-vehicle position awareness method comprising:
wirelessly sensing, by a host vehicle, a neighboring vehicle that is proximate to the host vehicle;
in response to wirelessly sensing the neighboring vehicle, generating neighboring vehicle data that indicates a position of the neighboring vehicle relative to the host vehicle;
generating a virtual traffic model for the host vehicle, using the neighboring vehicle data; and
the host vehicle wirelessly broadcasting host vehicle model data that conveys the virtual traffic model.

16. The method of claim 15, further comprising obtaining global positioning data for the host vehicle, wherein the virtual traffic model is generated in response to the neighboring vehicle data and the global positioning data.

17. The method of claim 16, further comprising calculating global positioning data for the neighboring vehicle from the neighboring vehicle data and the global positioning data for the host vehicle.

18. The method of claim 15, further comprising wirelessly receiving second neighboring vehicle model data from a second neighboring vehicle, the second neighboring vehicle model data conveying a second virtual traffic model for the second neighboring vehicle, wherein the virtual traffic model for the host vehicle is generated in response to the neighboring vehicle data and the second neighboring vehicle model data.

19. The method of claim 15, further comprising predicting impending traffic conditions proximate the host vehicle, based upon the virtual traffic model.

20. The method of claim 19, further comprising automatically controlling a subsystem of the host vehicle in a manner that is dependent upon predicted impending traffic conditions.
